(19) United States
(12) Patent Application Publication
(10) Pub. No.: US 2022/0027977 A1
(43) Pub. Date: Jan. 27, 2022

(54) SELF-IMPROVING, AUTOMATED, INTELLIGENT PRODUCT FINDER AND GUIDE

(71) Applicant: Artelliga, Inc., Anaheim, CA (US)

(72) Inventors: Mark RING, Anaheim, CA (US); Joel MORAIS, San Francisco, CA (US)

(21) Appl. No.: 17/443,133

(22) Filed: Jul. 21, 2021

Related U.S. Application Data
(60) Provisional application No. 62/705,921, filed on Jul. 22, 2020.

(51) Int. Cl. G06Q 30/06; G06Q 30/02; G06N 5/00; G06N 5/04; G06N 20/20; G06F 16/951; G06F 40/20

(52) U.S. Cl. CPC G06Q 30/0631; G06Q 30/0203; G06Q 30/0201; G06F 40/20; G06N 5/04; G06N 20/20; G06F 16/951; G06N 5/003

(57) ABSTRACT

A self-improving, automated, highly intelligent product finder/guide can be used by a user to access a web site running the computer recommendation engine to look for product in segment X (e.g., pool floats). The user takes a quiz, and the quiz recommends a product. The user is then taken to the seller's site to buy product. If user buys, the seller may pay a commission for having the buyer directed to the seller's site. The user can give feedback and suggestions, including suggesting new questions. Some goals of the system include short-term goals to increase the probability that user buys a product, and long-term goals to have the system of the present invention be the trusted source for people to find out which product is best for them. Reinforcement learning (RL) methods can be used to optimize these measurable quantities.

### CROSS-REFERENCE TO RELATED APPLICATIONS

This application claims the benefit of U.S. provisional patent application No. 62/705,921, filed Jul. 22, 2020, the contents of which are herein incorporated by reference.

### BACKGROUND OF THE INVENTION

### 1. Field of the Invention

One or more embodiments of the invention relates generally to computerized product finders and guides. More particularly, the invention relates to computerized product finder and guides that are automated and self-improving through artificial intelligence applications.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

There are businesses devoted to building product finders as B2B service. One conventional method is for selling SaaS B2B, in which clients connect up databases of products and features, choose questions to ask, choose order of questions to ask in a “conversation flow”, choose potential answers and choose how the Q&A lead to product recommendations. This method produces a website plug-in for the client to ask users the questions, make the product recommendations, monitor how many people are answering the questions and monitor how much time is spent on each question. Clients using this method have access to the platform interface and analytics, which reports on where in the graph people are continuing or not, shows sales performance of product recommendations, provides insights for clients to modify questions where customers are leaving the process and reports on various key performance indicators (KPIs) by other tracking information like browser and device type.

This conventional method appears to figure out which is the best ordering of up to three questions in part of the dialogue. For example, the method can attempt to minimize “click outs”—when the user ends the interaction. However, this feature is lacking because (1) it cannot optimize the whole conversation flow, just up to three adjacent questions selected by the user; (2) it only provides recommendations for optimization—it does not update the conversation flow automatically; and (3) the user needs to run the optimizer manually each time.

Another AI feature is the “Conversation Classifier”, which figures out how to combine raw product features together to calculate a more complex feature that might be important to a user. For example, a client may want to ask the consumer a question about the consumer's need for portability, but portability might not be a feature entered in the database. However, it might be possible to calculate a new “portability” value based on a combination of size and weight, which are values found in the product specification database. The method provides an AI product classifier that allows the client to simply choose examples of which of its products are “portable” and which products are not “portable”.

As can be seen, there is a need for a computerized product finder and guide that are automated and self-improving through artificial intelligence applications.

### SUMMARY OF THE INVENTION

Embodiments of the present invention provide a method for providing a computerized product finder and guide via a computer system comprising automatically generating, by the computer system, an interaction tree/graph comprising questions, answers and responses for a particular set of products; automatically generating the questions, answer and responses by reviewing data regarding the particular set of products; and dynamically organizing the questions, the answers and the responses during use of the product finder and guide based on user answers to the questions.

Embodiments of the present invention further provide a method for providing a computerized product recommendation to a user via a computer product recommendation engine comprising automatically generating, by the computer recommendation system, an interaction tree/graph comprising questions, answers and responses for a particular set of products; automatically generating the questions, answer and responses by reviewing data regarding the particular set of products; dynamically organizing the questions, the answers and the responses as the user answers the questions generated by the computer recommendation engine; and recommending a product to the user.

These and other features, aspects and advantages of the present invention will become better understood with reference to the following drawings, description, and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates multiple different processes for generating the different components of an interaction tree/graph, together with the relationships between data collection and optimization, according to an exemplary embodiment of the present invention;

FIG. 2 illustrates a zoomed-in perspective of the dynamic flow and optimization of an interaction according to an exemplary embodiment of the present invention;

FIG. 3 illustrates a functional block diagram illustration of a computer hardware platform that can be used to implement a particularly configured computing device that can host a computerized product finder engine according to an exemplary embodiment of the present invention; and

FIG. 4 illustrates an illustrative process related to methods for providing a computerized product finder and guide via a computer system.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); an interactive kiosk; a computer gaming console; a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols.

Embodiments of the present invention may include apparatuses for performing the operations disclosed herein. An apparatus may be specially constructed for the desired purposes.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a service/SaaS product that is a self-improving, automated, highly intelligent product finder/guide. The system can correlate the business side of sales with the reinforcement learning/optimization on the technical side, to create an automated, self-improving, universal sales agent that personalizes the sales interaction for any individual and for any consumer product. Furthermore, one embodiment of the service is when the service is not owned by or biased toward any particular manufacturer or reseller. The service can get to know both the products and the customers to whom the products are sold and personalize not just the recommendations but the entire interaction in order to optimize the sales process itself.

In some embodiments, the service can be a single very tiny, very specific product segment, where the technology can allow the system to expand quickly to other product segments. Scaling is an essential aspect of the system, product, and technology.

In some embodiments, a user comes to a site looking for a product in segment X (e.g., pool floats). The user takes a quiz, and the quiz recommends a product. The user is then taken to the seller's site to buy the product. If the user buys, the seller may pay a commission for having the buyer directed to the seller's site. The user can give feedback and suggestions, including suggesting new questions. Some goals of the system include short-term goals to increase the probability that a user buys a product, and long-term goals to have the system of the present invention be the trusted source for people to find out which product is best for them. Reinforcement learning (RL) methods can be used to optimize these measurable quantities.

Aspects of the present invention differ from the conventional methods in how the system of the present invention can be automated, and how the system can learn to sell products. Both of these are used to scale beyond a few new enterprise clients per year.

In some embodiments, the system of the present invention can automate the construction of a question tree/graph from data, including the sequencing of questions and the management of the dependencies between questions in the question tree/graph. It should be noted that questions frequently depend upon previous questions or upon the user's answers to those questions. Take for example the following two questions: (1) Do you prefer one-person floats or multi-person floats? (2) How many people should the float comfortably hold? Obviously, it only makes sense to ask the second question if the answer to the first question is “multi-person floats,” and it makes no sense to ask the questions in the opposite order.

Such questions need to be asked in a logical sequence such that (a) no question is asked before the required information for that question has already been given by the user; (b) no question is asked whose answer should already be known given answers the user has already provided. These dependencies are often critical to the flow of the questions, and the system of the present invention automates detection of these dependencies and the resulting logical ordering of the questions.

Logical orderings can be discovered using multiple techniques or a combination of techniques, including especially methods from artificial intelligence (AI), machine learning (ML) and reinforcement learning (RL). One such set of techniques from ML includes decision-tree algorithms (DTAs), which can build a tree of sequentially applied tests for classifying data samples into “categories” or “classes” when given a database of data samples, where each data sample in the database consists of (a) a set of “feature values” and (b) an associated category or class to which the data sample belongs. The DTA builds a tree of decision tests that allows the classification of each sample in the database into its corresponding class. The decision tree consists of a single “root” node together with any number of “child” nodes and any number of “leaves”. Each node (root or child) is associated with a particular test. Each leaf is associated with a category or class. Typically, in order to classify a data sample, the root test is applied first. Typically each test compares a single feature value from the sample to a fixed threshold value (e.g., whether or not the feature value is greater than the given threshold value), and based on the result of that test, the tree is descended in one direction or another, leading to either a child node or a leaf. If a child node, then the test corresponding to that child node is performed on the sample (testing the same or a different feature value). This test-and-descend process continues until a “leaf” of the tree is finally reached. Each leaf of the tree is associated with a category or class, and thus, upon reaching a leaf, the sample is classified into the category or class associated with that leaf.

If the samples in the database correspond to product features (e.g., “weight”, “color”, “price”, “durability”, and the like), then the “tests” can correspond to questions about these features that may be put to the user to query the user's preferences regarding the features of the product (e.g., “what is the maximum price you are willing to pay?”, “what is the most the product can weigh?” or the like). A database of product features can thereby be used to generate a decision tree of questions to ask a potential buyer/user. Depending on the user's answer to each question, the tree can be descended as above to arrive at the next test/question and eventually a leaf node. The “leaves,” “categories,” or “classes” of the tree in this case correspond to the product or products that match the user(s) preferences.

In should be noted that this general method can be extended to apply to vastly more kinds of data than product features, including demographic or personality features of buyers, and the like. Using DTAs on such data results in decision/question trees that choose which product to recommend based at least in part on personal characteristics of the buyer.

According to embodiments of the present invention, the DTA methods can generally recognize and discover decision/question dependencies automatically and can therefore construct decision/question trees that reflect the dependencies between the questions. If the database changes, the DTA can be re-run in order to quickly build a new tree from new or modified data. The DTA is generally devised to build trees that classify samples using the smallest number of tests but can also be modified to optimize other desired metrics. Furthermore, methods such as DTAs can be combined with other ML and AI methods such as neural networks (NNs) and RL to build on, enhance, or modify the decision tree and/or to optimize other potential metrics, such as likelihood of purchase, greatest customer satisfaction, or the like.

In some embodiments, a decision tree can be built, in the context of product finders, by associating question answers with sets of compatible products. In other words, let P be the set of all products that would be acceptable to a person choosing Answer y to Question x. For example, if Question x is “how many people would your pool float need to hold?” and answer y is “at least three”, then P_{xy} would be the set of all pool floats that hold three or more people. If in a given interaction Q¹ is the first question asked and A₁ the answer the user chooses; Qⁿ is the nth question asked during the interaction and Aⁿ is the answer the user chooses; P⁰ is the set of all products to be considered before any questions are asked, Pⁿ is the set of all products compatible with questions Q₁ through Qⁿ and answers A¹ through Aⁿ; then Pⁿ⁺¹=Pⁿ∩P_{xy} where x is Qⁿ⁺¹ and y is Aⁿ⁺¹. The decision tree can then be built in different ways towards different ends, such that each question is presented in the order that would best achieve a desired goal or metric; for example, always choosing the question that would eliminate as many products as possible at each step would keep the overall interaction length as short as possible (in general). In contrast, always choosing the question that would eliminate as few products as possible would extend the interaction as long as possible (in general). Other methods such as RL could be used to sequence the questions to optimize a vast range of other metrics as described below.

Aspects of the present invention can automate the construction, evaluation, and sequencing of answer alternatives for each question. The same techniques described above and throughout this document relating to creation, organization and optimal sequencing of questions also applies to the set of potential answers to each question from which the user may choose. While some questions might naturally require yes/no, true/false, or other specific answer alternatives, other questions may be more open ended and have greater flexibility for optimization in terms of the answer alternatives from which the user is allowed to choose. As noted above, the answer a user chooses for one question may directly impact the questions that can or should be asked later in the interaction.

Aspects of the present invention can automate the expansion of the question tree/graph interaction so as to include automated responses to the user during the course of the quiz/interaction, such responses including, for example, (1) styling and formatting of questions, pages, designs, and images on the user's screen; (2) textual responses regarding the decisions the user has made, such as “this product is trending” or “this product is a popular choice currently in your area” or “this product would go well with X” where X might be another product this user already has or is considering purchasing, and the like; (3) recommendation of one or more products; (4) voice or audible responses; and/or (5) any combination of the above that are not necessarily part of the questions or answers. Henceforth, “interaction” and “interaction sequence” refer to the entire repeating series of (a) a question and potential answers provided to the user, (b) user selection/choice of an answer, and, optionally, (c) a response to the user's answer (as described above).

Aspects of the present invention can automate the incorporation of questions, answers and/or responses (into interaction sequences) that are designed to learn information about the user, including information about the user's personal characteristics (e.g., demographics, background, needs, preferences, tastes, personality, and the like). These may include questions that are seemingly unrelated to the sale, but still may provide useable insight. For example, asking the user's favorite animal may lead to the insight that users having the same favorite animal are more likely to buy the same float. The system can determine how best to sell to that individual and/or to users with similar characteristics (e.g., demographic characteristics, personality characteristics, tastes, preferences or the like). This includes, for example, what kinds of questions, answers, and responses tend to lead toward higher sales, greater customer satisfaction, and/or other desired outcomes or metrics.

Aspects of the present invention can automate the incorporation of questions, answers, and responses (into interaction sequences) designed principally to entertain or increase user's engagement or satisfaction.

Aspects of the present invention can automate dynamically rebuilding/reconfiguring the interaction tree/graph with updated information, such as price, shipping speeds, latest reviews of the products, manufacturer's specs, and the like, whether (a) that information is drawn from the product database or another source; (b) that information pertains to the product or to the buyer. The information can be obtained by web scraping and natural language processing of various data, such as reviews, customer comments and the like. Small changes in this information can impact the entire structure of the tree/graph. It would take humans days or weeks of work to restructure the graph, if such is even possible considering the amount of data to be considered. The system of the present invention can restructure the graph billions of times per day. For example, if a review is posted, the system can scan the review for pertinent data and update the tree/graph accordingly. For example, if a review states the pool float worked well for a person weighing 250 pounds, the tree/graph can be updated with this usable weight information. Such an update could change the questions asked and/or the ordering of the questions.

Aspects of the present invention can automate the dynamic optimization (and re-optimization) of one or more interaction sequences. Once an interaction sequence is developed, it can be varied to optimize a chosen metric using other AI and ML techniques, such as RL. There are many potential RL methods that can be enlisted to optimize sequential decisions such as the interaction sequence considered in the present invention.

In general, RL algorithms interact with an external “environment” over time in the following manner. At each time step, the algorithm chooses an “action;” the action choice is transmitted to the environment; the environment responds by transmitting “state information” (generally a vector or matrix of data) and a “reward” back to the algorithm; and this process repeats indefinitely or until an optional point of “termination.” At every step before choosing an action, the RL algorithm may consider any or all of the state information and rewards it has received during the course of the interaction. Over time, the RL algorithm learns to choose actions at every time step that together maximize the (possibly discounted) cumulative amount of reward the algorithm receives over the entire course of an interaction.

In the case of the present invention, each “action” can be a question, set of answers, and/or responses sent to the user; the “state information” can include at least the answer chosen by the user, but can also include other information such as, by way of example (1) the amount of time that elapsed before the user made a decision; (2) the trajectory of the user's finger, cursor, or mouse before the user made a decision; (3) demographic information about the user; (4) personal or personality information about the user; (5) information regarding the similarity of this user to other users; and/or (6) information about the product or products being sold; and the like.

The reward value may be any measurable value, any optimizable parameter, or any combination thereof. The reward value can be chosen by the system to reflect the metric that the system's designers or operators have decided to optimize. For purposes of example, this value could include any of the following or combinations thereof: (1) 1.0 if the user chooses to buy the product, 0.0 otherwise; (2) the amount the user spends on the purchase; (3) the profit made on the sale of the product; (4) a user feedback rating given by the user at the end of the interaction or some subsequent time; and/or (5) 1.0 if the user returns to make another purchase, 0.0 otherwise; and the like.

RL algorithms are typically more versatile than DTAs and can be combined with or be built from DTAs as starting points, but with fewer constraints. For example, a product and a user can each be represented to the RL algorithm simply as vectors of real-numbered features. Questions, answers and responses can be represented in the same way. The RL algorithm can use this feature-based information to choose questions, answers, and responses in sequential order and in the context of similarly encoded state information without first building a specific decision tree. Instead, the algorithm encodes its behavior in the form of a “policy,” which describes the probability of each of its actions given its state information (which may encode its entire interaction sequence so far, together with any other information relevant to the decision, as described above and elsewhere in this document). The policy can then be improved through trial and learning to increase the probability of choosing actions that lead to greater reward.

Aspects of the present invention can automate the variation of questions, answers, responses (within the interaction sequence) and rewards so as to lead to the optimization of the interaction sequence to maximize any measurable quantity (metric) or multiple such metrics, such as (1) probability of sale/conversion (conversion rate), (2) size of purchase (conversion amount), (3) overall profit and/or profit margin, (4) customer satisfaction (when measurable), (5) customer return rate (retention), (6) customer “virality” (customer telling friends about our site), (7) entertainment value of quiz (user engagement), (8) length of quiz, and the like.

Aspects of the present invention can automate the collection of information about the user for use in the creation and optimization, as described above, of questions, answers, responses and interaction sequences. Such information can include, for example, information about the user that was received from the referring website. For example, a user clicking on a link on a referring website may arrive at the site operated by the system of the present invention accompanied by personal and/or demographic information from the referring website about the user, such as location, age, income, and the like. Such information can further include (1) personal and demographic information about the user that may be gathered using techniques such as determining the geographic location of the user's IP address, (2) personal information learned by asking the user questions, (3) personality characteristics that may be revealed by the answers the user provides to the questions as well as in the way that the user answers the questions (for example, how quickly the user answers the questions, or how directly the user moves the mouse to the selected answer, or how long the user hovers the mouse over other potential answers before making a final selection, and the like), and/or (4) such information gained from the user's previous visits to the site.

Aspects of the present invention can automate the optimization of each interaction sequence for each individual user or set of users with similar characteristics (e.g., demographic characteristics, personality characteristics, tastes, preferences or the like). This includes (1) dynamic real-time optimization of an interaction according to a user's individual personal and personality characteristics; and/or (2) automatic variation of all parameters of the interactions so as to find combinations that lead to improvements in the desired metric/reward. For example, if the system's goal is to increase user satisfaction with the interaction (measured perhaps by a rating selected by the user at the end of the interaction), then interactions can be varied and optimized using RL methods to find those variations that tend to lead to the highest ratings given a user's personal characteristics. E.g., different kinds of interactions may be needed to optimize the metric for seniors vs students vs grumpy people vs people who tend to return products vs people from Alabama, and the like.

Aspects of the present invention can automate the scheduling of when the next update and/or re-optimization should occur.

Aspects of the present invention can automate the collection and storage of any and all information arising during user interactions and/or learned about/from the users or user interactions, including all user information as described above and elsewhere herein and all data collected regarding the individual users and their individual activity during the interaction or interactions. All such information may be stored in a database for later use/re-use in at least the following ways: (1) The information may be associated with individual users so that, upon a user's return to the site, the need is reduced or eliminated to ask the user questions whose answers are already contained in the database. (2) The information may, in part or in whole, be used for improving any of the user's interactions when returning to the site, including creation and optimization of interactions. (3) The information may be amalgamated with the data of other users in order to identify patterns and/or features that are similar or correlated across such users, may be predictive of the users' individual or group behavior and/or tendencies, and may therefore be used for creation and optimization of interactions.

Aspects of the present invention can automate the incorporation of the stored information in the creation and/or optimization of future interactions, product searches, or the like, whether specifically for that person or for other similar persons (having similar characteristics, as described above) or more generally. Such information may be used, for example, by an RL algorithm to decide which questions to ask and in which sequence so as to maximize the reward, thus optimizing any metric or parameter over the course of the interaction, such as, for example, the probability of purchase at a third-party site, the amount of the purchase, the user's satisfaction rating, or the like.

Aspects of the present invention can automate the collecting/harvesting of information available online so as, for example, to: (1) find product categories to sell in real-time, e.g., top-tending products; (2) find products to sell within each category in real-time, e.g., top-rated products; (3) find and incorporate numeric product data into the database, including product specifications, price, physical characteristics, shipping speeds, reliability scores, consumer ratings, and the like; (4) discover any other product properties or features, or other information potentially important to potential purchasers, whether for users generally or for individual, specific users; (5) discover and potentially optimize the phrasing of questions related to the above product data, properties, or features; (6) discover potential answers to such questions; and/or (7) find supporting data about the product corresponding to such potential answers.

Aspects of the present invention can automate the analysis of online reviews in order to, for example, (1) discover consumer sentiment regarding products; (2) verify the validity of online reviews; (3) compare products against each other; (4) decide whether or not to recommend a product; (5) catalog a product's features (both positive and negative); discover which questions to ask regarding these features; (6) discover which answers are appropriate for such questions; (7) discover which answers to which questions are consistent with which products and/or user personalities/preferences; (8) modify the probability that the system will recommend a product; and/or (9) modify the probability that the system will recommend a product to a particular person or set of persons with similar characteristics (e.g., demographic or personality characteristics and the like as described above); and the like.

Aspects of the present invention can automate the analysis, processing and/or use of such information collected online to (1) construct or enhance product entries in the database with feature information for specific, identified products or similar groups of products; (2) construct or enhance interactions, including questions, answers, responses, and interaction trees/graphs, or parts thereof, (3) optimize interactions and interaction trees/graphs for specific products or groups of products and/or for specific users or groups of users, or combinations thereof; and/or (4) automatically generate and optimize interactions for new products and classes of products.

Aspects of the present invention can automate the collection and storage of crowd-sourced data, including suggested questions, answers, responses, product recommendations, product-guide requests (i.e., requests by users that the site develop the product finder/guide in specific ways and/or for additional categories of products), usage statistics (how people use the site), and/or other suggestions.

Aspects of the present invention can automate the evaluation, incorporation, and optimization of crowd-sourced information, including questions, answers, responses, product recommendations, product-guide requests and usage statistics, for all uses as described above as well as for automatically generating and optimizing interactions for new products and classes of products.

Aspects of the present invention can automate the generation of explanations that inform users about a product, its features, and/or why a product is recommended to the user, such as that the product (1) has the features required by or fulfilling the preference requests of the user as expressed during the course of the quiz, (2) has features matching the user's personal characteristics and/or personality traits, (3) is preferred by similar users, and/or (4) has features not necessarily requested in the quiz or known to the user but which are likely of interest or desirability to the user, who might view them as an additional “bonus” and/or incentive.

The system of the present invention can be used to sell either business-to-business (B2B) or business-to-consumer (B2C). B2B would be similar to what conventional systems are doing now, but more automated by the various system automation features discussed above. In B2C, the system of the present invention offers a significant advantage.

In principle, the system of the present invention can sell any product to any person because, these days, most products can be advertised and sold online for a commission. For example, Amazon's Affiliate/Associate program enables the system to advertise any product sold by Amazon, give a person a product quiz, recommend a product, and collect a commission if the person buys the product. The same is true for many other sellers and retailers, and there is a general trend for manufacturers and retailers to create such affiliate programs. As a result, anyone having a highly effective method for selling can build a scalable business out of simply selling; and becoming a trusted source of recommendations, via the system of the present invention, is one such way to do that.

Accordingly, the B2C model, according to aspects of the present invention, targets the following: (1) becoming a “Universal Product Finder” by replacing product research for the user and guiding customers to the best products for their individual needs; (2) establishing trust, such as by (a) providing reliably good recommendations—recommending products that are as good or better than users find doing the research themselves; (b) providing the users with information the user finds important and relevant; (c) giving the user a feeling of satisfaction at the way that the interaction flowed; (d) asking questions that allow users to express their feelings and desires, and then responding to those expressions appropriately; (e) asking questions and/or creating interactions that are entertaining or that users find otherwise engaging; and/or (f) quality assurance: only recommending high quality products from trusted sellers; (3) individualizing online sales so that customers get the kind of personal, individualized recommendations from knowledgeable sales agents that previously were only possible from human sales representatives; (4) using optimization methods (as described above and elsewhere in this document) to (a) maximize customer satisfaction, loyalty, and “virality” (the degree to which existing customers recommend a product to others), (b) optimize other traditional sales metrics and objectives, and (c) enable and enhance achievement of 1-3 of this paragraph.

As described herein, aspects of the present invention can automate the interactive sales process such that the system can become an automated, self-improving, universal sales person for any individual and any consumer product. The service provided by the system of the present invention can get to know both the products and the customers the products are sold to in order to individualize and optimize the entire sales process.

While in the above description, the user chooses one answer from among a small number of alternatives, in principle the system may be more flexible. For examples, the user could choose multiple ones of the given alternatives, move a slider to a position on a scale that corresponds to a real-valued response (e.g., how much the user agrees with a statement, or how much the user wants to spend, or the like), and/or simply answer in natural language. This could be particularly valuable in a voice implementation where the user is asked questions and is allowed to answer them, and the system uses natural language processing (NLP) tools to classify the answer.

It should be noted that maximizing customer satisfaction often entails more than just eliminating products whose features conflict with the user's requests. Frequently, no non-conflicting product exists, or too many such products exist, and a guess has to be made as to which product will make the user happiest. This can be done using personal information, including personality characteristics, and the like, and basing the guess on what was chosen by the user in the past or by other similar users, as described elsewhere in this document.

The technology, according to aspects of the present invention, is specifically designed to make all of these targets achievable through automated mechanisms.

The business model and technology also allow the system to be particularly nimble—to find, advertise, and sell whichever products are trending or are currently most lucrative.

In particular, the system, according to aspects of the present invention, can, without human assistance, optimize an entire interaction to maximize a specific metric (as described above). It should be noted that people are not machines and are highly subject to influence and persuasion during the sales process. This is what good salespeople understand well and how they are able to keep their customers satisfied. Even small things can have a big impact on sales and retention, such as the order in which questions are asked and the feedback/responses provided to the customer during the interaction.

The system according to aspects of the present invention can build, measure, and track categories of buyers so the interaction tree/graph can be personalized to each kind of buyer as a group. Other conventional product finders approach the entire process upside down—they categorize products into features to help buyers navigate the features, but this is only half the picture. A good salesperson categorizes the buyers into the groups that tend to prefer each product. The job of sales is often to ask questions in order to decide the category of buyer to which a customer belongs. Once a user has been categorized, then the recommendation can be the product bought by others in that category of buyer. For example, imagine that buyers of a certain pool float tend to be women, aged 40-55, whose household annual income is 60-120 k, who have 1 to 3 children, who enjoy meeting new people, who live in Florida or Southern California, whose favorite color is pink, and who like flamingos. In that case, perhaps the quickest way to find the float a person likes best is to ask questions that elicit this kind of information.

The methods of the present invention can do both—(1) ask about the buyer's feature preferences; and (2) ask personal questions about the buyer. Then, the methods can bootstrap from relying more on the first (1) to the second (2) as more data is collected so that personal information can be gradually discovered and used to recommend products. It should be noted that this personal information can be retained (opt-in) so that when people return to the site, the product finder already can use this information to make recommendations about other products. For example, users will be able to create an account or agree to cookies for saving their data.

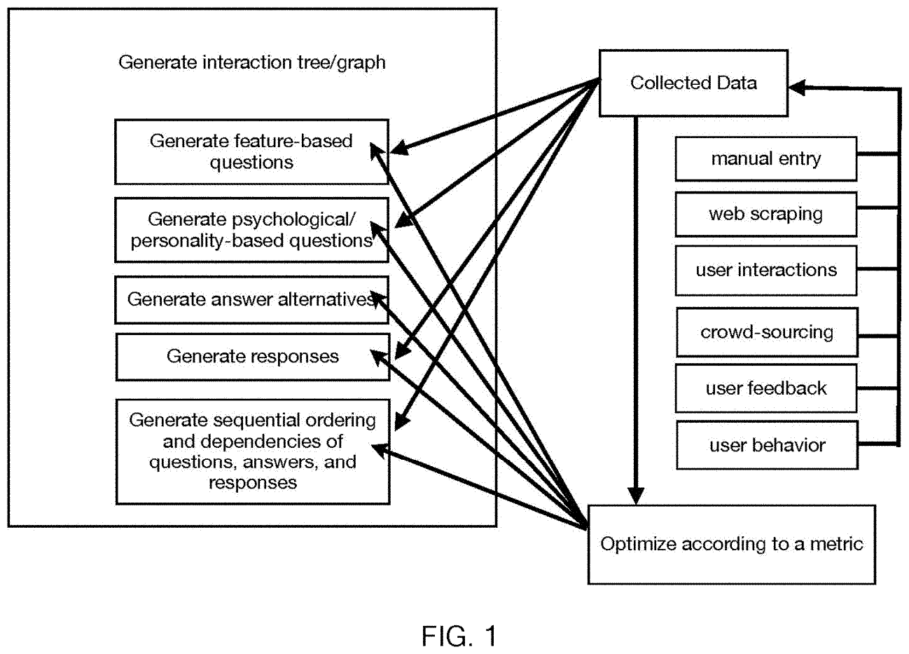

Referring to FIG. 1, there are shown multiple different processes for generating the different components of an interaction tree/graph, together with the relationships between data collection and optimization. Arrows cutting into a box indicate that the process can be modified, whereas arrows stopping at the edge of a box mean merely that data is supplied.

As can be seen in FIG. 1, the collected data can include, for example, manual data entry, web scraping, user interactions, crowd-sourced data, user feedback, user behavior data, and the like. Such data can be supplied to help generate the interaction tree/graph as illustrated. The interaction tree/graph can include several elements, including, as exemplary examples, generating feature-based questions, generating psychological/personality-based questions, generating answer alternatives, generating responses and generating the ordering and dependencies of questions, answers and responses. As discussed above, this ordering and dependency can be changed based on the collected data, the metric to be optimized, the user's previous responses in any given interaction, saved user information, and the like.

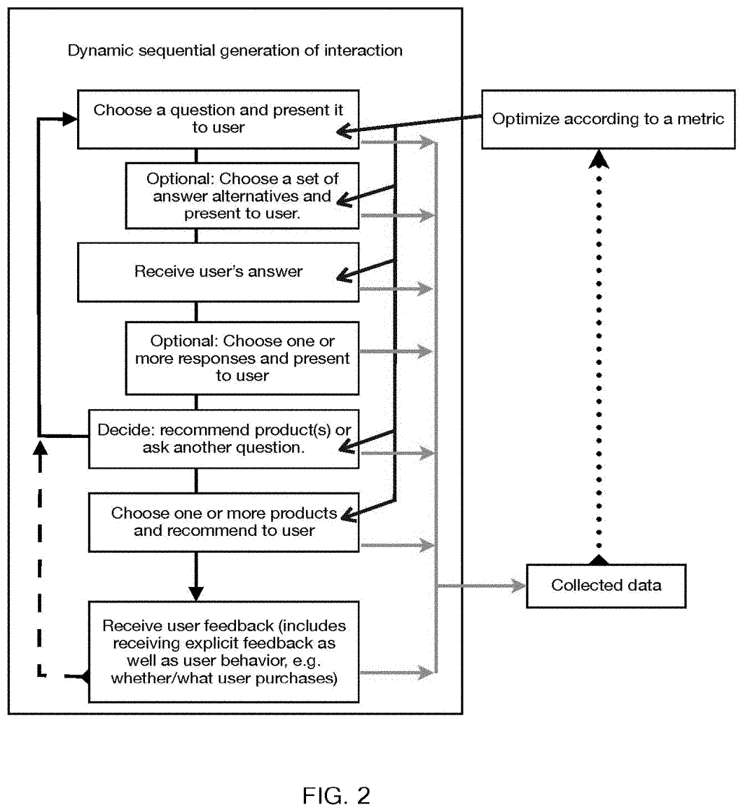

FIG. 2 illustrates a zoomed-in perspective of the dynamic flow and optimization of an interaction as it is taking place, showing the temporal flow of question, answer, response, recommendation, and feedback together with (a) how some user data (interaction data) can be collected (horizontal arrows pointing to the right) and provided to (dotted line) the optimization process, and (b) how that optimization process informs (sloped lines pointing to the left) the decisions made during the interaction.

As can be seen, the system chooses a question to be presented to a user. The user may be provided a set of answer alternatives, or the user may be permitted to provide a free-form answer. As discussed above, the questions may be presented visually, audibly, or both, for example, and the responses may be made in a similar manner. Once the system receives the user's answers, the system can choose one or more responses to present to the user. The system may then decide whether to ask another question or to recommend one or more products to the user. The system can also receive feedback. Such feedback may be, for example, direct feedback from the user regarding the interaction, questions, and the like, or may be indirect feedback, such as that related to the user's behavior, such as whether the user made a purchase and if the user purchased the recommended item. After the recommendation the user may optionally continue the interaction in order to get additional recommendations, and/or take additional product quizzes for the same or other product categories.

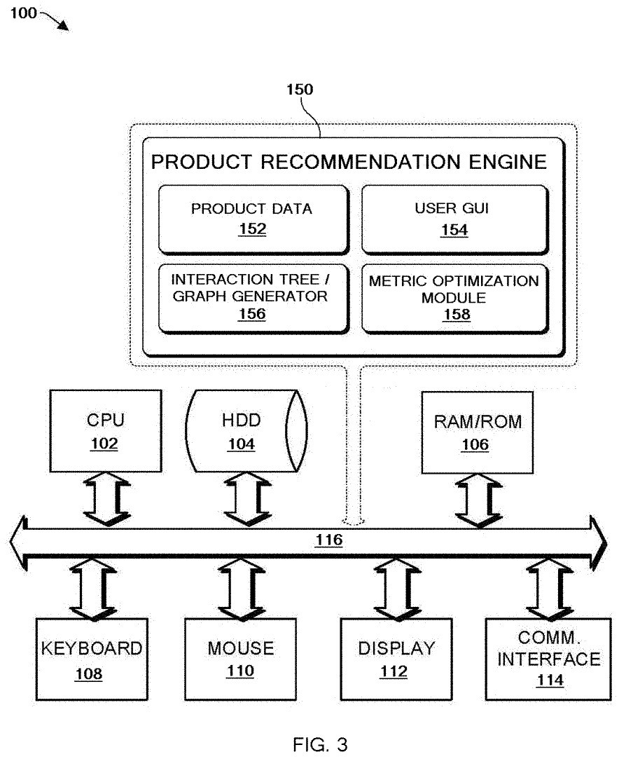

FIG. 3 provides a functional block diagram illustration of a computer hardware platform 100 that can be used to implement a particularly configured computing device that can host a computerized product finder engine 150. The computerized product finder engine 150, can include a product data receipt module 152, a user graphical user interface (GUI) 154, an interaction tree/graph generator 156 and a metric optimization module 158.

The product data receipt module 152 can receive product data, perform web scraping to obtain data, receive customer data, receive product reviews, and the like, as discussed above, in order for the interaction tree/graph generator 156 to generate an initial interaction sequence. As discussed above, the initial interaction sequence can change, dynamically, during use by a user as the user answers questions via the user GUI 154. The metric optimization module 158 can use machine learning algorithms and/or reinforcement learning, as discussed above, to dynamically arrange the questions in efforts to optimize one or more predetermined metrics.

The computer hardware platform 100 can include one or more computing devices including appropriate network connections, cloud-based storage, or the like. For example, the user GUI 154 may be located and/or displayed at a user client device in communication with the computerized product finder engine 150.

The computer platform 100 may include a central processing unit (CPU) 102, a hard disk drive (HDD) 104, random access memory (RAM) and/or read only memory (ROM) 106, a keyboard 108, a mouse 110, a display 112, and a communication interface 114, which are connected to a system bus 116. The communication interface 114 may provide an internal, wired, or wireless connection, such as Wi-Fi®, Bluetooth®, or the like.

In one embodiment, the HDD 104, has capabilities that include storing a program that can execute various processes, such as the computerized product finder engine 150, in a manner described herein.

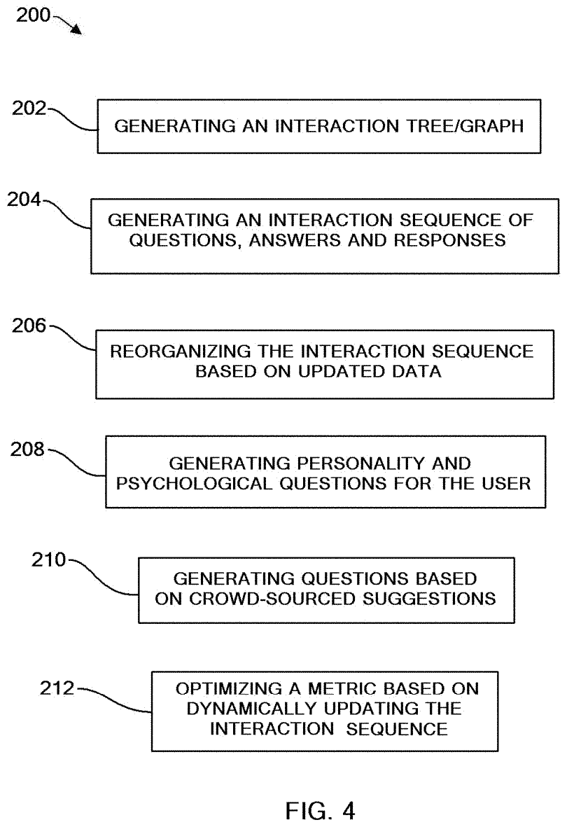

With the foregoing overview of the exemplary system for providing a computerized product finder, it may be helpful now to consider a high-level discussion of exemplary processes. To that end, FIG. 4 presents an illustrative process 200 related to methods for providing a computerized product finder and guide via a computer system. Process 200 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Process 200 can include a step 202 of generating an interaction tree/graph and a further step 204 of generating an interaction sequence of questions, answers and responses by reviewing data regarding a particular set of products. The process 200 can further include a step 206 of reorganizing the interaction sequence based on updated data received by the computer system. This reorganization can be dynamic, occurring while the user is operating the product finder and answering questions. For example, the data used for the reorganization may be data from the user's own answers, data received from web scraping, data received from other users' interactions, and the like. The process 200 can include a step 208 of optionally generating personality and psychological questions for the user. Further, a step 210 of optionally generating one or more questions based on crowd-sourced suggestions may be used in the process 500. Finally, the process 200 can include a step 212 of optimizing a metric based on dynamically updating the interaction sequence. This optimization may be performed using various AI techniques, including machine learning algorithms and reinforcement learning, as discussed above. The optimization can be arrived at through reorganizing the interactions and seeing how people respond, calculating scores that assign credit to the different components of the interaction, using these scores to adjust the probabilities that different components are chosen for different parts of the interaction, recalculating those values depending on (among other things) user choices and the outcomes of the interaction. This optimization process can occur at any time and to any extent as data is received.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for providing a product recommendation to a user via a computer system, the method comprising:
automatically generating, by the computer system, an interaction tree/graph comprising questions, answers and responses for a particular set of products;
receiving input from the user as user answers to the automatically generated questions; and
recommending a product from the particular set of products to the user.

2. The method of claim 1, wherein the interaction tree/graph is generated by a machine learning technique including decision tree algorithms.

3. The method of claim 1, further comprising building the interaction graph/tree by initially associating question answers with sets of compatible products and limiting the sets of compatible products as a user answers the questions.

4. The method of claim 1, further comprising automatically generating the questions, answers and responses based on a database of product-question-response relationships.

5. The method of claim 1, further comprising automatically generating the questions, answers, responses and/or recommendations based on at least one of data harvested by the computer system, crowd-sourced suggestions, and personality based questions, answers, responses and recommendations.

6. The method of claim 1, further comprising automatically generating the questions, answers, responses and/or recommendations based on at least one of data that includes manufacturer data, data from sellers of one or more of the particular set of products, and/or data from consumer reviews, where the data is obtained via web scraping and optionally extracted using natural language processing.

7. The method of claim 1, further comprising optimizing the interaction tree/graph according to a metric.

8. The method of claim 7, wherein metric includes at least one of customer satisfaction, conversions, revenue, and profit.

9. The method of claim 7, further comprising understanding and influencing the user based on answers to personality questions or psychological questions.

10. The method of claim 1, further comprising incorporating one or more questions, answers, responses and/or recommendations into the interaction graph/tree that are designed to entertain or increase a user's engagement or satisfaction.

11. The method of claim 1, further comprising optimizing the questions, answers, responses and/or recommendations to learn features about a user and tagging the user with features to help make recommendations for other users with similar features.

12. The method of claim 1, wherein an algorithm for optimizing the interaction tree/graph according to a metric can use at least a portion of information about the user, wherein the information includes at least one of user's answers in a current and/or a prior interaction, user behavior, and/or user demographics.

13. The method of claim 1, wherein an algorithm for optimizing the interaction tree/graph according to a metric can use one or more of an amount of time that elapsed before the user made a decision; a trajectory of a finger, cursor or mouse of the user before the user made the decision; demographic information about the user; personal or personality information about the user; crowd sourced data; information regarding similarity between the user and other users including user features, purchasing preferences, behaviors and tendencies of the other users; and information about a product or products being sold.

14. The method of claim 1, further comprising using reinforcement learning on data available to the computer system to optimize a metric.

15. The method of claim 1, further comprising reorganizing the questions, the answers, the responses and/or the recommendations during execution of the method by the user.

16. The method of claim 1, further comprising reorganizing the questions, the answers, the responses and/or the recommendations based on updated data received by the computer system.

17. The method of claim 16, wherein the updated data includes at least one of personal information about a user, information known about the product or found online, price, shipping speeds, latest reviews, updated manufacturer specifications, and experience of other users that have used the product finder and guide for the particular set of products.

18. A method for selling a recommended product to a user by providing a computerized product recommendation to the user via a computerized product recommendation engine, the method comprising:
automatically generating, by the computerized product recommendation engine, an interaction tree/graph comprising questions, answers and responses for a particular set of products;
automatically generating the questions, answers and responses by reviewing data regarding the particular set of products;
dynamically organizing the questions, the answers and the responses as the user answers the questions generated by the computerized product recommendation engine; recommending a product to the user; and
directing a user to a seller of the recommended product.

19. The method of claim 18, further comprising saving personality and psychological information about the user, wherein at least one of the saved personality and psychological information, along with product data, data from other users and optimization data, is retrieved to dynamically organize the questions, the answers and the responses when the user uses the computerized product recommendation engine the first and/or subsequent times.

20. The method of claim 18, further comprising reorganizing the questions, the answers and the responses based on updated data received by the computerized product recommendation engine.
